(19) United States
(12) Patent Application Publication
(10) Pub. No.: US 2022/0339568 A1
(43) Pub. Date: Oct. 27, 2022

(54) FILTER UNIT AND METHOD FOR MANUFACTURING THE SAME

(71) Applicant: TOYU CORPORATION, Yokohama-shi Kanagawa (JP)

(72) Inventors: Toshihisa TOYAMA, Yokohama-shi (JP); Masayo TOYAMA, Yokohama-shi (JP); Yutaro TOYAMA, Yokohama-shi (JP); Daisuke KAWASHIMA, Yokohama-shi (JP); Hiroyasu TAKENO, Yokohama-shi (JP); Tsuyoshi SATO, Yokohama-shi (JP)

(73) Assignee: TOYU CORPORATION, Yokohama-shi Kanagawa (JP)

(21) Appl. No.: 17/433,754

(22) PCT Filed: Sep. 30, 2020
(86) PCT No.: PCT/JP2020/037360

§ 371 Date: Aug. 25, 2021

(51) Int. Cl. B01D 46/00; B01D 46/52; B01D 46/12; B01D 46/64; B01D 46/62

(52) U.S. Cl. CPC B01D 46/0001; B01D 46/521; B01D 46/12; B01D 46/64; B01D 46/645; B01D 46/0005; B01D 2265/04; B01D 2267/40; B01D 2275/205; F24F 8/108

(57) ABSTRACT

The filter unit includes a filter section having a first filter and a second filter being of a pleated shape, and a frame having a pair of first frames and a pair of second frames having an adhesive layer. The filter unit is manufactured by stacking the first filter on the second filter, arranging a first support member opposite to the first frame with respect to a first fixed portion, arranging a second support member for supporting the second fixed portion opposite to the first frame with respect to the second fixed portion, fixing the first frame to the first fixed portion and the second fixed portion, and fixing the first frame to the second frame.

### TECHNICAL FIELD

The present invention relates to the filter unit and a method for manufacturing the same.

### BACKGROUND ART

Conventional filter device is known to have a two-layer structure including a pre-filter and a filter media (e.g., Patent Literature 1). In the filter device, the pre-filter and the filter media are restrained from the top by an upper restraining plate and from the bottom by a lower restraining plate to form a filter body, and the filter body is fixed to a mounting frame. The bottom of the mounting frame is provided with linear protrusions for guiding the filter body into the mounting frame. In another embodiment, the upper and lower restraining plates are configured to have a thickness approximately equal to that of the filter media. This allows the filter body to be held more firmly in the mounting frame.

Other air filters are known in which a pre-filter and a filter pack are integrally held with a frame (e.g., Patent Literature 2). A sealing material for fixing the pre-filter to the frame is provided at an upstream end of the upper and lower surfaces of the pre-filter, and a sealing material for fixing the filter pack to the frame is provided at a downstream end of the upper and lower surfaces of the filter pack. This makes it possible to reduce weight and facilitate filter replacement work compared to the case where a sealant is provided on the entire surface.

### CITATION LIST

### Patent Literature

Patent Literature 1: Japanese Patent No. 6275957

Patent Literature 2: Japanese Patent No. 6243146

### SUMMARY OF INVENTION

### Technical Problem

However, in the filter device described in Patent Literature 1, the pre-filter and the filter media are fixed only at the top and bottom thereof, resulting in an unstable state. In addition, the filter device is configured so that the filter body having the pre-filter and the filter media restrained in the filter body is fixed to the mounting frame, which increases the number of parts in the filter device.

In the air filter described in Patent Literature 2, since the pre-filter and the filter pack are partially fixed to the frame, a strong adhesive force cannot be secured. When the filter is clogged, the seal material may peel off, causing air to leak from the peeled part.

Although a multilayered integrated filter unit with multiple functions is desired, it is difficult to stack flexible nonwoven fabrics in multiple layers and fit them into the frame without gap. In particular, pleated filters are stacked in multiple layers in order to provide high filtration performance, but this is difficult in terms of manufacturing technology and a new manufacturing method is required.

In view of the foregoing, an object of the present invention is to provide a filter unit configured to hold multi-layered filter in a single unit.

### Solution to Problem

In order to solve the above problem, the first invention provides a method for manufacturing a filter unit comprising: a rectangular filter section having at least a first filter and a second filter overlapped with the first filter, the second filter being folded alternately with mountains and valleys in a stretch direction so as to form a pleated shape and having a first fixed portion located at one end portion of the stretch direction and a second fixed portion located at other end portion of the stretch direction; and a frame surrounding the filter section, wherein the frame comprises: a pair of first frames having a first adhesive layer to which the filter section is attached, the first frames supporting the filter section from the stretch direction; and a pair of second frames having a second adhesive layer to which the filter section is attached, the second frames supporting the filter section from a fold direction orthogonal to the stretch direction, the method comprising the steps of: overlapping the first filter with the second filter; arranging a first support member, which is configured to support the first fixed portion, opposite to the first frame with respect to the first fixed portion; arranging a second support member, which is configured to support the second fixed portion, opposite to the first frame with respect to the second fixed portion; fixing the first fixed portion and the second fixed portion to the first adhesive layer; separating the first support member from the first fixed portion; separating the second support member from the second fixed portion; fixing an end portion of the first filter in the fold direction and an end portion of the second filter in the fold direction to the second adhesive layer; and fixing the first frame to the second frame.

The second invention provides the method for manufacturing the filter unit according to the first invention, wherein the filter section is supported by an assembly frame configured to support the first filter and the second filter from the fold direction at the time of overlapping, wherein the first support member and the second support member are configured to be detachable to the assembly frame, and wherein the assembly frame is separated from the filter section when the end portion of the first filter in the fold direction and the end portion of the second filter in the fold direction are fixed to the second adhesive layer.

The third invention provides the method for manufacturing the filter unit according to first or second invention, wherein the filter section further comprises a third filter folded alternately with mountains and valleys in the stretch direction so as to form a pleated shape and a protective net, the method further comprising the steps of: overlapping the third filter on the first filter or the second filter; arranging the protective net at a most downstream side of an air flow direction; arranging a third support member, which is configured to support a third fixed portion provided at one end portion of the third filter in the stretch direction, opposite to the first frame with respect to the third fixed portion; arranging a fourth support member, which is configured to support a fourth fixed portion provided at the other end portion of the third filter in the stretch direction, opposite to the first frame with respect to the fourth fixed portion; fixing the third fixed portion, the fourth fixed portion, and an end portion of the protective net in the stretch direction to the first adhesive layer; separating the third support member from the third fixed portion; separating the fourth support member from the fourth fixed portion; and fixing an end portion of the third filter in the fold direction and an end portion of the protective net in the fold direction to the second adhesive layer.

The fourth invention provides a filter unit comprising: a rectangular filter section having at least a first filter and a second filter overlapped with the first filter, the second filter being folded alternately with mountains and valleys in a stretch direction so as to form a pleated shape and having a fixed portion located at an end portion of the stretch direction; and a frame surrounding a periphery of the filter section, wherein the frame comprises: a pair of first frames having a first adhesive layer to which the filter section is adhered, the first frames supporting the filter section from the stretch direction; and a pair of second frames having a second adhesive layer to which the filter section is adhered, the second frames supporting the filter section from a fold direction orthogonal to the stretch direction, wherein the frame is configured to be a separate unit for each edge of the filter section, wherein the fixed portion of the filter section is adhered to the first adhesive layer and end portions of the first filter and the second filter in the fold direction are adhered to the second adhesive layer, and wherein the first frame and the second frame are adhered to each other.

The fifth invention provides the filter unit according to fourth invention 4, wherein the filter section further comprises a third filter folded alternately with mountains and valleys in the stretch direction so as to form a pleated shape, and wherein the first filter is disposed between the second filter and the third filter so as to be sandwiched between a top portion of the second filter and a top portion of the third filter.

The sixth invention provides the filter unit according to fourth and fifth invention, wherein the frame has squared U-shape in cross section and comprises: a base portion to which the filter portion is adhered; a first projecting portion provided at one end portion of a stack direction in which the first filter and the second filter overlap, and a second projecting portion at the other end portion of the stack direction, wherein the first projection has a height from the base portion different from that of the second projection.

The seventh invention provides the filter unit according to any one of fourth to sixth inventions, wherein the frame is made of resin and is made of material having light transmittance.

The eighth invention provides the filter unit according to seventh invention, wherein the resin of the frame has a haze greater than 0% and less than or equal to 63%.

The ninth invention provides the filter unit according to any one of fourth to eighth inventions, wherein the filter section further comprises a protective net for protecting the filter section at a most downstream side of an air flow direction, and wherein the protective net has an end portion in a compressed direction fixed to the first frame and an end portion in the fold direction fixed to the second frame.

### Advantageous Effects of the Invention

According to the first invention, since the first support member supports the first fixed portion of the second filter from the opposite side of the first frame and the second support member supports the second fixed portion of the second filter from the opposite side of the first frame, the first frame can be fixed to the filter section in a stable state. The second filter is of the pleated shape, and thus the second filter shrinks at the time of being fixed to the first frame, making the manufacturing work difficult. However, according to the present invention, since the second filter is supported by the first support member and the second support member, the first frame can be fixed to the second filter without the shrinkage of the second filter. The first support member and the second support member are finally separated from the first and second fixed portions, so they do not become the components of the filter unit and do not affect the filtration performance. Since the first frame has the first adhesive layer to which the filter section is fixed, the filter section can be stably fixed to the frame. Since the second frame has the second adhesive layer to which the end portion of the second filter in the fold direction is adhered, the second filter having the pleated shape can be stably fixed to the second frame.

Since the filter section is held by a pair of divided first frames and a pair of divided second frames, the frame can hold the filter section integrally without separating each layer despite the multi-layer of the filter section. Since the first frame and the second frame are fixed to each other, the frame can hold the filter section more firmly.

According to the second invention, since the first support member and the second support member are detachable from the assembly frame, the first support member can be separated from the first fixed portion and the second support member can be separated from the second fixed portion in a simple manner. Since the assembly frame is separated from the filter section when fixing the end portion of the first filter in the fold direction and the end portion of the second filter in the fold direction to the second adhesive layer of the second frame, the assembly frame does not become an obstacle when the second frame is fixed to the filter section.

According to the third invention, since the filter section further includes the third filter having the pleated shape, the filtration performance of the filter unit can be further improved and its service life can be extended. Since the third support member supports the third fixed portion of the third filter and the fourth support member supports the fourth fixed portion of the third filter, the first frame can be fixed to the filter section in a stable state. The third filter is of the pleated shape, and thus the third filter shrinks at the time of being fixed to the first frame, making the manufacturing work difficult. However, according to the present invention, since the filter section is supported by the third support member and the fourth support member, the first frame can be fixed to the third filter without the shrinkage of the third filter. In addition, the filter unit having a plurality of pleated filters can be manufactured by employing the first support member, the second support member, the third support member, and the fourth support member for manufacturing the filter unit. Since the filter section includes the protective net on the most downstream side of the air flow direction, the filter section can be prevented from being damaged by external force. In addition, each layer of the filter section can be prevented from falling off the frame.

According to the fourth invention, since the filter section is held by a pair of divided first frame and a pair of divided second frame, the frame can hold the filter section integrally without separating each layer despite the multi-layer of the filter section. In particular, since the frame includes a pair of first frames and a pair of second frames, the second filter can be stably held. Since the first frame and the second frame are fixed to each other, the filter section can be stably held by the frame. The first frame is provided with the first adhesive layer to fix the filter section, so the filter section can be stably fixed to the frame. The second frame is provided with the second adhesive layer, to which the end portion of the second filter in the folded line direction is adhered, so that the second filter can be stably fixed to the second frame.

According to the fifth invention, the first filter is sandwiched between the top portion of the second filter and the top portion of the third filter, which avoid moving the first filter within the filter section. This prevents the decrease in the filtration performance due to the gaps occurring by wrinkles in the first filter.

According to the sixth invention, since the first projecting portion and the second projecting portion protrude from the base portion of the first frame, the first projecting portion or the second projecting portion receive the applied adhesives, thereby suppressing leakage to the outside. Since the first projecting portion and the second projecting portion have different heights from the base portion, the upstream or downstream side of the filter unit in the air flow direction can be determined based on the height of the projecting portions.

According to the seventh invention, since the frame is made of resin having a certain degree of rigidity, the shape of the filter unit can be maintained even when external force is applied. In addition, since the frame is made of a material that transmits light, the contamination state of the filter section can be seen from the outside. This configuration makes it possible to properly determine the time for replacement of the filter unit.

According to the eighth invention, since the haze of the frame is 63% or less, the contamination state of the filter unit can be seen from the outside. This configuration makes it possible to properly determine the time for replacement of the filter unit.

According to the ninth invention, since the protective net is provided on the most downstream side of the filter section in the air flow direction, the filter section can be prevented from being damaged by external force. In addition, each layer of the filter section can be prevented from falling off the frame.

### BRIEF DESCRIPTION OF DRAWINGS

FIG. 1 A perspective view of a filter unit mounted in an air purifier according to a first embodiment of the present invention.

FIG. 2 A front view of the filter unit according to the first embodiment of the present invention.

FIG. 3 An exploded perspective view of the filter unit according to the first embodiment of the present invention.

FIG. 4 A cross-sectional view of the filter unit according to the first embodiment of the present invention.

FIG. 5 A view of the filter unit according to the first embodiment of the present invention, FIG. 5(a) shows a cross-sectional view of a first frame, FIG. 5(b) shows a cross-sectional view of a second frame.

FIG. 6 A flowchart for manufacturing the filter unit according to the first embodiment of the present invention.

FIG. 7 A perspective view of the filter unit to explain the manufacturing process according to the first embodiment of the present invention.

FIG. 8 A view of the filter unit according to the first embodiment of the present invention, FIG. 8(a) shows a cross-sectional view prior to fix the second frame to a filter section, FIG. 8(b) shows a cross-sectional view after fixing the second frame to the filter section.

FIG. 9 A partial enlarged view of a fixed portion between the first frame and the second frame of the filter unit according to the first embodiment of the present invention.

FIG. 10 An exploded perspective view of a filter unit according to a second embodiment of the present invention.

FIG. 11 A front view of a filter unit according to a third embodiment of the present invention.

### DESCRIPTION OF EMBODIMENTS

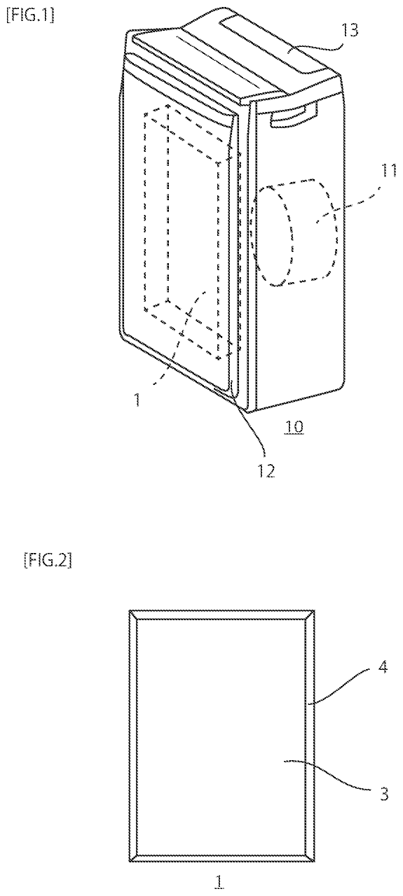

The filter unit 1 according to the first embodiment of the present invention will be described with reference to FIGS. 1 to 9. As shown in FIG. 3, front-rear, top-bottom, and right-left directions are defined. The front-rear direction corresponds to a stretch direction of the present invention, and the left-right direction corresponds to a fold direction of the present invention.

The filter unit 1 is a filter mainly used in an air purifier 10. The air sucked from an inlet 12 by the rotation of a fan 11 passes through the filter unit 1 to remove dust, and then the purified air is discharged from an exhaust 13. The filter unit 1 is not limited to be applied to air purifiers but may be used in electrical equipment such as air conditioners and vacuum cleaners, automobiles, air conditioning device, clean rooms, and may also be applied to dust collection filters and oil filters.

The filter unit 1 has a roughly rectangular parallelepiped shape and includes a filter section 3 having multi-layered filters, and a frame 4 holding the filter section 3. A porous elastic material, such as sponge, is provided in a space where the filter unit 1 is stored in the air purifier 10 so as to be in contact with the four corners of the frame 4. The provision of the elastic material reduces the transmission of vibrations generated by the fan 11 of the air purifier 10 to the filter unit 1.

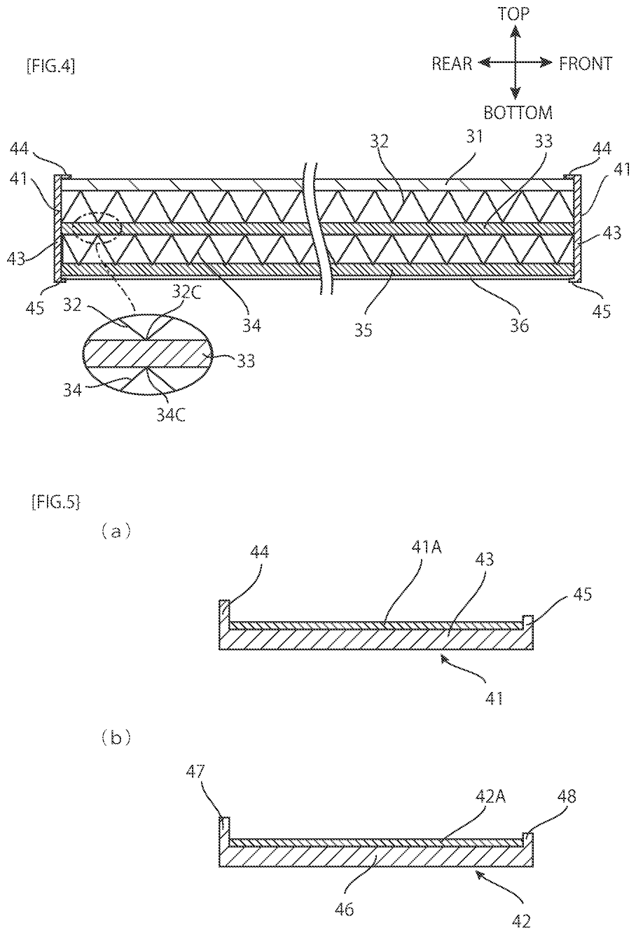

As shown in FIGS. 3 and 4, the filter section 3 includes a pre-filter 31, a first pleated filter 32, an intermediate filter 33, a second pleated filter 34, an end filter 35, and a protective net 36. In the filter unit 1, the pre-filter 31 is provided at an upstream side of an air flow direction and the protective net 36 is provided at a downstream side of the air flow direction. In other words, the air flows through the filter section 3 from top to bottom. Each filter of the filter section 3 is composed of a fiber body such as a non-woven fabric or a woven fabric made of fibers such as glass fibers, resin fibers, etc.

The pre-filter 31 as a first layer is a medium performance filter in sheet form and is made of a material configured to catch coarse dust whose particles are 50 μm or larger.

The first pleated filter 32 as a second layer is of a pleated shape by repeating mountain and valley folds so that the fold lines extending in the right-left direction arranged in parallel in the front-rear direction. The first pleated filter 32 is stretchable in the front-rear direction due to its pleated shape. The first pleated filter 32 is the medium performance filter similarly to the pre-filter 31, and the pleated shape ensures filtration area for catching dusts. The first pleated filter 32 employs a high-strength filter material to prevent the breakage. The first pleated filter 32 has a first fixed portion 32A at its front end surface, and a second fixed portion 32B at its rear end surface.

The intermediate filter 33 as a third layer is a sheet HEPA filter and is made of a material configured to catch particles of 0.3 μm or larger. The filter is used in many fields such as semiconductors, liquid crystals, pharmaceuticals, and food manufacturers, and can be used in clean rooms from class 100 to 10000. The intermediate filter 33 can also catch the PM2.5.

The second pleated filter 34 as a fourth layer has the same configuration as the first pleated filter 32 and is made of the same material. The second pleated filter 34 has a third fixed portion 34A at its front end surface and a fourth fixed portion 34B at its rear end surface. The end filter 35 as a fifth layer is the same HEPA filter as the intermediate filter 33 and is made of an abbreviated identical material. The protective net 36 is configured to prevent the filter layers, i.e., from the pre-filter 31 to the end filter 35, from falling out. The protective net 36 is located at the most downstream side of the air flow direction and is composed of elastic resin with a mesh shape. The first fixed portion 32A, the second fixed portion 32B, the third fixed portion 34A, and the fourth fixed portion 34B correspond to the fixed portion of the present invention.

Each filter comprising the filter section 3 is not limited to the above, and any filter may be used. For example, an ULPA filter configured to catch particles of 0.1 μm may be used in any of the first to fifth layers, or a non-woven fabric filter configured to inactivate viruses may be used in any of the first to fifth layers. The high performance filter is desirably arranged downstream side in the air flow direction, and the filter configured to inactivate viruses is desirably arranged in the middle. The number of layers is not limited as long as the pleated filter is used in at least one layer of the filter section 3. For example, the number of layers can be set arbitrarily from two to five or more layers. In addition, the shape is not limited to a rectangular parallelepiped shape, but can be a cylindrical shape as well. The pre-filter 31 or the intermediate filter 33 is an example of the first filter of the present invention, the first pleated filter 32 is an example of the second filter of the present invention, and the second pleated filter 34 is an example of the third filter of the present invention.

The frame 4 includes a pair of first frames 41 and a pair of second frames 42. The frame 4 is made of a polypropylene resin having rigidity and light transmittance, but it is not limited to this and any material can be selected. For example, polyethylene, polyvinyl chloride, polyethylene terephthalate, cellulosic plastics, polystyrene, polycarbonate, polyvinyl alcohol, etc. can be used. The haze representing the cloudiness rate of the frame 4 is preferably at 63% or less, and more preferably 62.4% or less. The frame 4 may be made of a highly transparent resin with a haze greater than 0%.

As shown in FIG. 3, the first frames 41 have a roughly squared U-shape in cross section and holds the filter section 3 in the front-rear direction. As shown in FIG. 5(a), the first frame 41 includes a first adhesive layer 41A, a base portion 43 to which the filter section 3 is adhered, a first projecting portion 44 located at one end of the base portion 43, and a second projecting portion 45 located at the other end of the base portion 43. The first projecting portion 44 protrudes higher than the second projecting portion 45. The first adhesive layer 41A is provided so as to cover the base portion 43, but it is not limited thereto and may be provided so as to cover at least a part of the base portion 43.

As shown in FIG. 3, the second frame 42 has a roughly squared U-shape in cross section and holds the filter section 3 from the right-left direction. As shown in FIG. 5(b), the second frame 42 has a second adhesive layer 42A, a base portion 46 to which the filter section 3 is adhered, a first projecting portion 47 located at one end of the base portion 46, and a second projecting portion 48 located at the other end of the base portion 46. The first projecting portion 47 protrudes higher than the second projecting portion 48. The second adhesive layer 42A is provided so as to cover the base portion 46, but it is not limited thereto and may be provided so as to cover at least a part of the base portion 46.

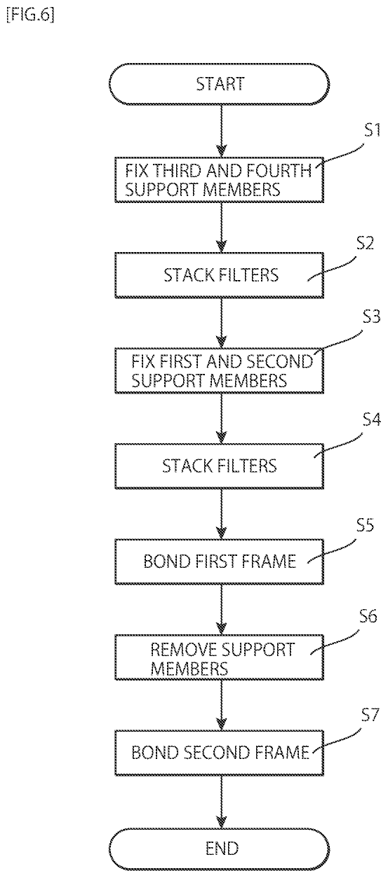

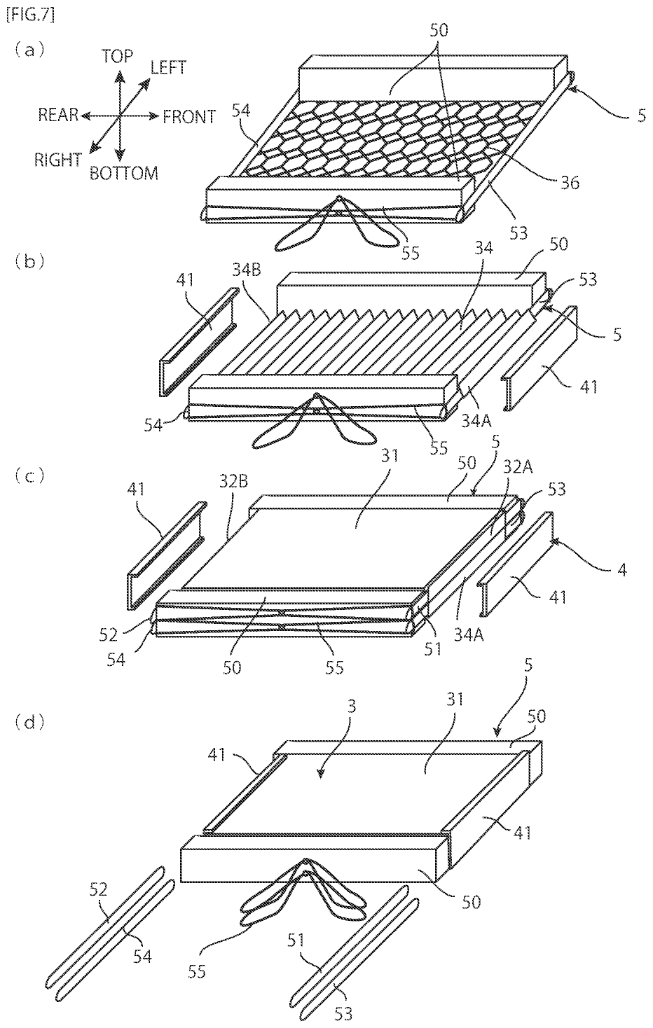

Next, the manufacturing method of the filter unit 1 will be described with reference to FIGS. 6 and 7. The manufacturing method of the filter unit 1 uses an assembly frame 5 when each layer is overlapped and then fixed to the frame 4. The assembly frame 5 includes a pair of side walls 50, a first support member 51, a second support member 52, a third support member 53, a fourth support member 54, and a rubber 55. The length of the side walls 50 in the front-rear direction is approximately the same as the length of the filter section 3 in the front-rear direction. The rubber 55 is provided on each of the side walls 50.

The third support member 53 is of a thin flat plate shape, and has the height in the vertical direction shorter than the distance between the fold lines of the second pleated filter 34 and the width in the right-left direction longer than the distance between the side walls 50. An operator hooks left and right rubbers 55 onto portions of the third support member 53 that protrudes from the side walls 50. As a result, the third support member 53 is fixed to the lower front side of the side walls 50 (S1).

The fourth support member 54 is approximately the same shape as the third support member 53, and has both ends in the right-left directions protruding from the side walls 50. The operator hooks the right and left rubbers 55 onto the portions of the fourth support member 54 that protrude from the side walls 50 in the right-left direction. As a result, the fourth support member 54 is fixed to the lower rear side of the side walls 50. As shown in FIG. 7(a), the operator places the protective net 36 on an assembly space 5a of the assembly frame 5.

As shown in FIG. 7(b), the operator overlaps the end filter 35 on top of the protective net 36, and overlaps the second pleated filter 34 on top thereof (S2). At this time, the second pleated filter 34 is placed such that the third fixed portion 34A is hooked onto the third support member 53 and the fourth fixed portion 34B is hooked onto the fourth support member 54. In other words, the third support member 53 is located on the rear side of the third fixed portion 34A, and the fourth support member 54 is located on the front side of the fourth fixed portion 34B. That is, the third support member 53 is located on the opposite side of the first frame 41 with respect to the third fixed portion 34A, and the fourth support member 54 is located on the opposite side of the first frame 41 with respect to the fourth fixed portion 34B.

The operator places the first support member 51 directly above the third support member 53 and fixes the same to the side walls 50 with rubber 55, and also places the second support member 52 directly above the fourth support member 54 and fixes the same to the side walls 50 with rubber 55 (S3). Specifically, similarly to the third support member 53, the operator hooks right and left rubbers 55 onto portions, which protrude in the right-left direction from the side walls 50, of the first support member 51 and the second support member 52. The operator overlaps the intermediate filter 33 on top of the second pleated filter 34 and overlaps the first pleated filter 32 on top of the intermediate filter 33 (S4).

As shown in FIG. 7(c), the first pleated filter 32 is placed such that the first fixed portion 32A is hooked to the first support member 51 and the second fixed portion 32B is hooked to the second support member 52. In other words, the first support member 51 is located on the rear side of the first fixed portion 32A, and the second support member 52 is located on the front side of the second fixed portion 32B. That is, the first support member 51 is located on the opposite side of the first frame 41 with respect to the first fixed portion 32A, and the second support member 52 is located on the opposite side of the first frame 41 with respect to the second fixed portion 32B. At this time, as shown in the enlarged partial view enclosed by the single-dotted chain line in FIG. 4, the intermediate filter 33 is sandwiched between a first top portion 32C of the first pleated filter 32 and a second top portion 34C of the second pleated filter 34. In other words, the first top portion 32C is positioned approximately in a straight line with the second top portion 34C with a space therebetween, and the intermediate filter 33 is disposed between them.

The operator overlaps the pre-filter 31 on top of the first pleated filter 32, and presses the first frame 41 against the filter section 3 so that the first fixed portion 32A and the third fixed portion 34A are in contact with the first adhesive layer 41A (S5). At this time, the first frame 41 is adhered to the filter section 3 so that the first projecting portion 44 of the first frame 41 is positioned on the upper side. Although the filter section 3 is made of non-woven fabric material and is flexibly deformed upon applying the strong pressures, the first frame 41 can integrally hold the multi-layered filter owing to the support from rear side of the first support member 51 and the third support member 53. In addition, since the intermediate filter 33 is sandwiched between the first pleated filter 32 and the second pleated filter 34, adhesion failure of the intermediate filter 33 can be prevented. The intermediate filter 33 is an intermediate layer, so adhesion failure tends to easily occur due to floating between the end surface of the intermediate filter 33 and the first adhesive layer 41A. However, since the intermediate filter 33 is fixed by being sandwiched between the first pleated filter 32 and the second pleated filter 34, the intermediate filter 33 can be firmly adhered to the first adhesive layer 41A.

The operator presses the first frame 41 against the filter section 3 so that the second fixed portion 32B and the fourth fixed portion 34B are in contact with the first adhesive layer 41A. In the same way, the first frame 41 is adhered to the filter section 3 so that the first projecting portion 44 of the first frame 41 is positioned on the upper side. Although the filter section 3 is made of non-woven fabric material and is flexibly deformed upon applying the strong pressures, the first frame 41 can integrally hold the multi-layered filter owing to the support of the second support member 52 and the fourth support member 54. In addition, instead of the first adhesive layer 41A, an adhesive may be applied to at least one of the filter side and the first frame 41.

As shown in FIG. 7(d), after the first frame 41 and the filter section 3 are fixed, the first support member 51, the second support member 52, the third support member 53, and the fourth support member 54 are removed from the side walls 50 (S6).

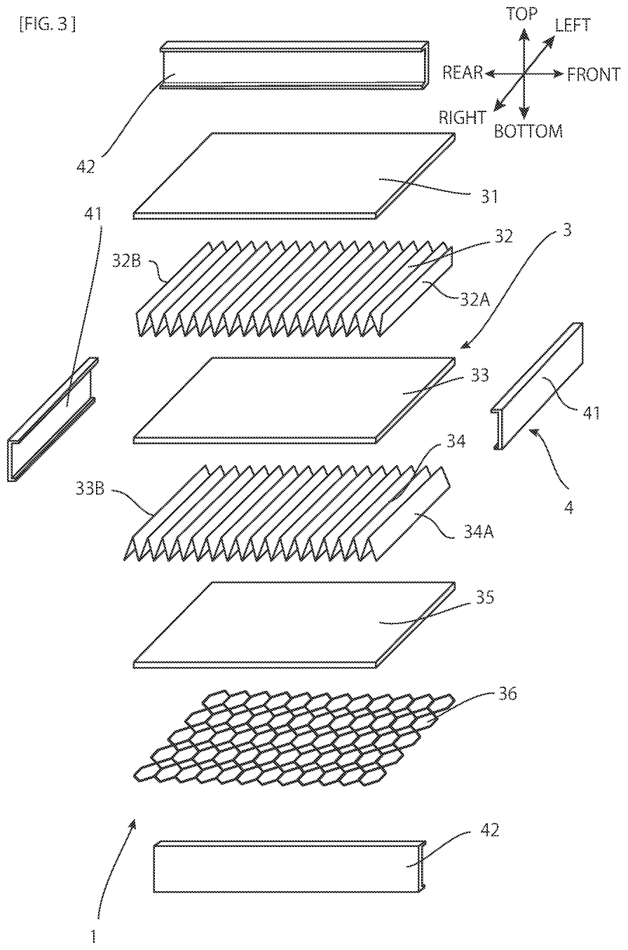

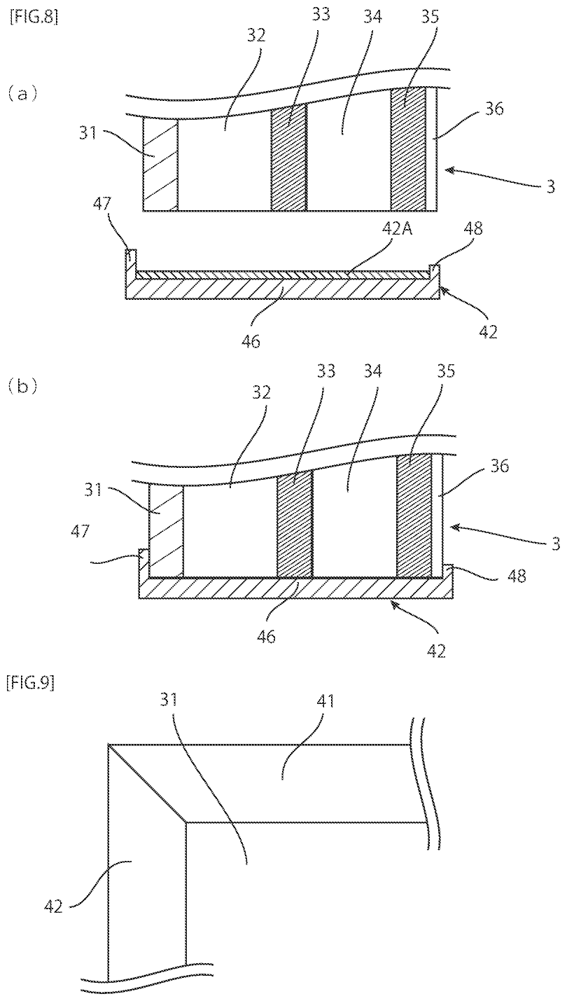

The operator moves the side walls 50 away from the filter section 3 and presses the second frame 42 against the filter section 3 from the right-left direction (S7). The filter section 3 is brought into close to the second frame 42 as shown in FIG. 8(a), and the end of the filter section 3 in the right-left direction is inserted into the second adhesive layer 42A as shown in FIG. 8(b). At this time, as shown in FIG. 9, contact points of the first frame 41 and the second frame 42 are fixed to each other at the end faces at approximately 45° with respect to the longitudinal direction. Then, the filter unit 1 is completely manufactured as shown in FIG. 2.

According to this configuration, since the first support member 51 supports the first fixed portion 32A of the first pleated filter 32 from the opposite side of the first frame 41 and the second support member 52 supports the second fixed portion 32B of the first pleated filter 32 from the opposite side of the first frame 41, the first frame 41 can be fixed to the filter section 3 in a stable state. The first pleated filter 32 is of the pleated shape, and thus the first pleated filter 32 shrinks at the time of being fixed to the first frame 41, making the manufacturing work difficult. However, according to the present invention, since the first pleated filter 32 is supported by the first support member 51 and the second support member 52, the first frame 41 can be fixed to the first pleated filter 32 without the shrinkage of the first pleated filter 32. The first support member 51 and the second support member 52 are finally separated from the first and second fixed portions 32A and 32B, so they do not become the components of the filter unit 1 and do not affect the filtration performance. Since the first frame 41 has the first adhesive layer 41A to which the filter section 3 is fixed, the filter section 3 can be stably fixed to the frame 4. Since the second frame 42 has the second adhesive layer 42A to which the end portion of the first pleated filter 32 in the fold direction is adhered, the first pleated filter 32 having the pleated shape can be stably fixed to the second frame 42.

Since the filter section 3 is held by a pair of divided first frames 41 and a pair of divided second frames 42, the frame 4 can hold the filter section 3 integrally without separating each layer despite the multi-layer of the filter section 3. Since the first frame 41 and the second frame 42 are fixed to each other, the frame 4 can hold the filter section 3 more firmly.

According to this configuration, since the first support member 51 and the second support member 52 are detachable from the assembly frame 5, the first support member 51 can be separated from the first fixed portion 32A and the second support member 52 can be separated from the second fixed portion 32B in a simple manner. Since the assembly frame 5 is separated from the filter section 3 when fixing the end portion of the pre-filter 31 or the intermediate filter 33 in the fold direction and the end portion of the first pleated filter 32 in the fold direction to the second adhesive layer 42A of the second frame 42, the assembly frame 5 does not become an obstacle when the second frame 42 is fixed to the filter section 3.

According to this configuration, since the filter section 3 further includes the second pleated filter 34 having the pleated shape, the filtration performance of the filter unit 1 can be further improved and its service life can be extended. Since the third support member 53 supports the third fixed portion 34A of the second pleated filter 34 and the fourth support member 54 supports the fourth fixed portion 34B of the second pleated filter 34, the first frame 41 can be fixed to the filter section 3 in a stable state. The second pleated filter 34 is of the pleated shape, and thus the second pleated filter 34 shrinks at the time of being fixed to the first frame 41, making the manufacturing work difficult. However, according to the present invention, since the filter section 3 is supported by the third support member 53 and the fourth support member 54, the first frame 41 can be fixed to the second pleated filter 34 without the shrinkage of the second pleated filter 34. In addition, the filter unit having a plurality of pleated filters can be manufactured by employing the first support member 51, the second support member 52, the third support member 53, and the fourth support member 54 for manufacturing the filter unit 1. Since the filter section 3 includes the protective net 36 on the most downstream side of the air flow direction, the filter section 3 can be prevented from being damaged by external force. In addition, each layer of the filter section 3 can be prevented from falling off the frame 4.

According to this configuration, the elastic material is provided in the space where the filter unit 1 is stored in the air purifier 10, thereby filling gap therebetween and suppressing the rattling despite the existence of some gap when mounting the filter unit into the air purifier 10. In addition, this configuration can prevent the direct transmission of vibrations from the motor and other components to the filter unit 1.

According to this configuration, since the filter section 3 is held by a pair of divided first frame 41 and a pair of divided second frame 42, the frame 4 can hold the filter section 3 integrally without separating each layer despite the multi-layer of the filter section 3. In particular, since the frame 4 includes a pair of first frames 41 and a pair of second frames 42, the first pleated filter 32 can be stably held. Since the first frame 41 and the second frame 42 are fixed to each other, the filter section 3 can be stably held by the frame 4. The first frame 41 is provided with the first adhesive layer 41A to fix the filter section 3, so the filter section 3 can be stably fixed to the frame 4. The second frame 42 is provided with the second adhesive layer 42A, to which the end portion of the first pleated filter 32 in the folded line direction is adhered, so that the first pleated filter 32 can be stably fixed to the second frame 42.

According to this configuration, the intermediate filter 33 is sandwiched between the first top portion 32C of the first pleated filter 32 and the second top portion 34C of the second pleated filter 34, which avoid moving the intermediate filter 33 within the filter section 3. This prevents the decrease in the filtration performance due to the gaps occurring by wrinkles in the intermediate filter 33.

According to this configuration, since the first projecting portion 44 and the second projecting portion 45 protrude from the base portion 46 of the first frame 41, the first projecting portion 44 or the second projecting portion 45 receive the applied adhesives, thereby suppressing leakage to the outside. Since the first projecting portion 44 and the second projecting portion 45 have different heights from the base portion 43, the upstream or downstream side of the filter unit in the air flow direction can be determined based on the height of the projecting portions.

According to this configuration, since the frame 4 is made of resin having a certain degree of rigidity, the shape of the filter unit 1 can be maintained even when external force is applied. In addition, since the frame 4 is made of a material that transmits light, the contamination state of the filter section 3 can be seen from the outside. This configuration makes it possible to properly determine the time for replacement of the filter unit 1.

According to this configuration, since the haze of the frame 4 is 63% or less, the contamination state of the filter unit 1 can be seen from the outside. This configuration makes it possible to properly determine the time for replacement of the filter unit 1.

According to this configuration, since the protective net 36 is provided on the most downstream side of the filter section 3 in the air flow direction, the filter section 3 can be prevented from being damaged by external force. In addition, each layer of the filter section 3 can be prevented from falling off the frame 4.

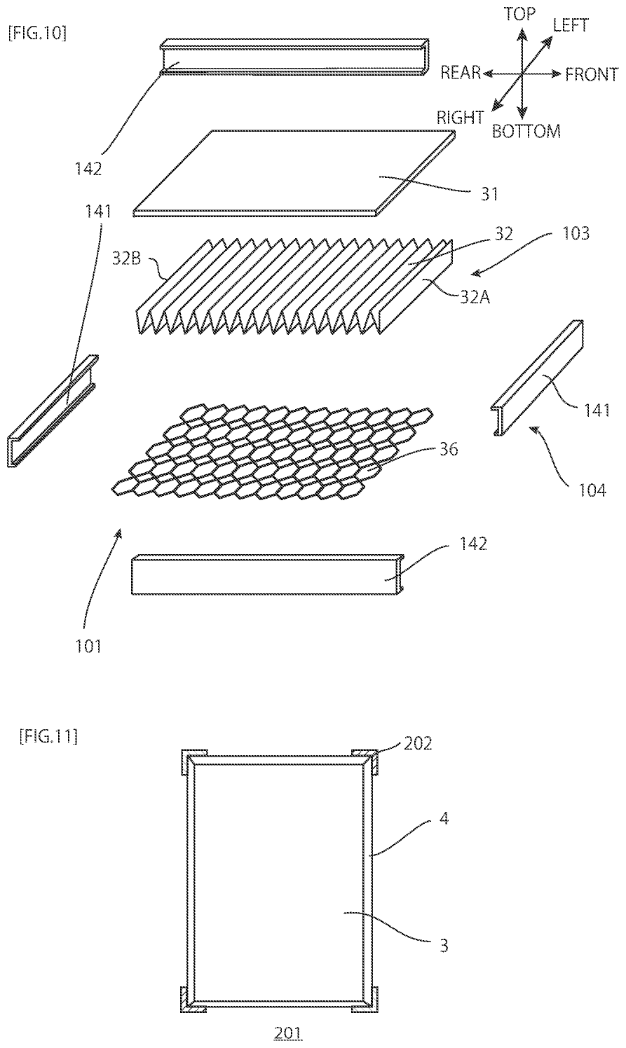

Next, the second embodiment of the present invention will be described with reference to FIG. 10. The same configuration as in the above-mentioned embodiment will be indicated with the same reference numerals and the explanation will be omitted.

The filter unit 1 of the first embodiment was composed of five layers, while a filter unit 101 of the second embodiment is composed of two layers. The filter unit 101 of the second embodiment includes a filter section 103 having a pre-filter 31, a first pleated filter 32, and a protective net 36.

A frame 104 includes a first frame 141, and a second frame 142. The vertical height of the frame 104 is slightly higher than the height of the filter section 103. The configuration of the frame 104 is approximately the same as that of the frame 4 of the first embodiment, so detailed descriptions are omitted.

When manufacturing the filter unit 101, the frame 104 is fixed to the filter section 103 using only the first support member 51 and the second support member 52. The manufacturing method is approximately the same as the manufacturing method of the first embodiment, and therefore detailed descriptions are omitted.

According to this configuration, the filter unit 101 can integrally holds the first pleated filter 32 having the pleated shape and the pre-filter 31.

Next, a third embodiment of the present invention will be described with reference to FIG. 11. The same configuration as in the above-mentioned embodiment will be indicated with the same reference numerals and the explanation will be omitted.

In a filter unit 201 of the third embodiment, elastic materials 202 are provided at the four corners of the frame 4, thereby filling gap and suppressing the rattling despite the existence of the gap when mounting the filter unit 201 to the air purifier 10. In addition, this configuration can prevent the direct transmission of vibrations from the motor and other components to the filter unit 201.

The filter unit and the manufacturing method of the filter unit according to the present invention are not limited to the above-mentioned embodiments, and various changes are possible within the scope of the gist of the invention described in the claims.

### REFERENCE SIGNS LIST

1,101,201 filter unit
3 filter section
4 frame
5 assembly frame
31 pre-filter
32 first pleated filter
32A first fixed portion
32B second fixed portion
32C first top portion
33 intermediate filter
34 second pleated filter
34A third fixed portion
34B fourth fixed portion
34C second top portion
35 end filter
36 protective net
41 first frame
41A first adhesive layer
42 second frame
42A second adhesive layer
43, 46 base portion
44, 47 first projecting portion
45, 48 second projecting portion
50 side walls
51 first support member
52 second support member
53 third support member
54 fourth support member
55 rubber

1. A method for manufacturing a filter unit comprising: a filter section having at least a first filter and a second filter overlapped with the first filter, the second filter being folded alternately with mountains and valleys in a stretch direction so as to form a pleated shape and having a first fixed portion located at one end portion of the stretch direction and a second fixed portion located at other end portion of the stretch direction; and a frame surrounding a periphery of the filter section and comprising: a pair of first frames having a first adhesive layer to which the filter section is attached, the first frames supporting the filter section from the stretch direction; and a pair of second frames having a second adhesive layer to which the filter section is attached, the second frames supporting the filter section from a fold direction orthogonal to the stretch direction, the method comprising the steps of:
overlapping the first filter with the second filter;
arranging a first support member, which supports the first fixed portion, opposite to the first frame with respect to the first fixed portion;
arranging a second support member, which supports the second fixed portion, opposite to the first frame with respect to the second fixed portion;
fixing the first fixed portion and the second fixed portion to the first adhesive layer;
separating the first support member from the first fixed portion;
separating the second support member from the second fixed portion;
fixing an end portion of the first filter in the fold direction and an end portion of the second filter in the fold direction to the second adhesive layer; and
fixing the first frame to the second frame.

2. The method for manufacturing the filter unit according to claim 1, wherein the filter section is supported by an assembly frame that supports the first filter and the second filter from the fold direction at the time of overlapping,
wherein the first support member and the second support member are detachably provided to the assembly frame, and
wherein the assembly frame is separated from the filter section when the end portion of the first filter in the fold direction and the end portion of the second filter in the fold direction are fixed to the second adhesive layer.

3. The method for manufacturing the filter unit according to claim 1, wherein the filter section further comprises a third filter folded alternately with mountains and valleys in the stretch direction so as to form a pleated shape and a protective net,
the method further comprising the steps of:
overlapping the third filter on the first filter or the second filter;
arranging the protective net at a most downstream side of an air flow direction;
arranging a third support member, which supports a third fixed portion provided at one end portion of the third filter in the stretch direction, opposite to the first frame with respect to the third fixed portion;
arranging a fourth support member, which supports a fourth fixed portion provided at the other end portion of the third filter in the stretch direction, opposite to the first frame with respect to the fourth fixed portion;
fixing the third fixed portion, the fourth fixed portion, and an end portion of the protective net in the stretch direction to the first adhesive layer;
separating the third support member from the third fixed portion;
separating the fourth support member from the fourth fixed portion; and
fixing an end portion of the third filter in the fold direction and an end portion of the protective net in the fold direction to the second adhesive layer.

4. A filter unit comprising:
a rectangular filter section having at least a first filter having a sheet shape, a second filter overlapped with the first filter, and a third filter disposed opposite to the second filter with respect to the first filter, the second filter being folded alternately with mountains and valleys in a stretch direction so as to form a pleated shape and having a fixed portion located at an end portion of the stretch direction, the third filter being folded alternately with mountains and valleys in the stretch direction so as to form a pleated shape; and
a frame surrounding a periphery of the filter section,
wherein the frame comprises:
a pair of first frames having a first adhesive layer to which the filter section is adhered, the first frames supporting the filter section from the stretch direction; and
a pair of second frames having a second adhesive layer to which the filter section is adhered, the second frames supporting the filter section from a fold direction orthogonal to the stretch direction,
wherein the frame is configured to be a separate unit for each edge of the filter section,
wherein the fixed portion of the filter section is adhered to the first adhesive layer and end portions of the first filter and the second filter in the fold direction are adhered to the second adhesive layer, and
wherein the first frame and the second frame are adhered to each other.

5. The filter unit according to claim 4, wherein the first filter is disposed between the second filter and the third filter so as to be sandwiched between a top portion of the second filter and a top portion of the third filter.

6. The filter unit according to claim 4, wherein the frame has squared U-shape in cross section and comprises:
a base portion to which the filter portion is adhered;
a first projecting portion provided at one end portion of a stack direction in which the first filter and the second filter overlap, and
a second projecting portion at the other end portion of the stack direction,
wherein the first projection has a height from the base portion different from that of the second projection.

7. The filter unit according to claim 4, wherein the frame is made of resin and is made of material having light transmittance.

8. The filter unit according to claim 7, wherein the resin of the frame has a haze greater than 0% and less than or equal to 63%.

9. The filter unit according to claim 4, wherein the filter section further comprises a protective net for protecting the filter section at a most downstream side of an air flow direction, and
wherein the protective net has an end portion in the stretch direction fixed to the first frame and an end portion in the fold direction fixed to the second frame.
